(19) United States
(12) Patent Application Publication
(10) Pub. No.: US 2018/0105462 A1
(43) Pub. Date: Apr. 19, 2018

(54) MANUFACTURING METHOD OF OPTICAL FIBER AND OPTICAL FIBER

(71) Applicant: SUMITOMO ELECTRIC INDUSTRIES, LTD., Osaka (JP)

(72) Inventors: Kensaku SHIMADA, Yokohama-shi (JP); Kazuyuki SOHMA, Yokohama-shi (JP); Yuya HOMMA, Yokohama-shi (JP)

(73) Assignee: SUMITOMO ELECTRIC INDUSTRIES, LTD., Osaka (JP)

(21) Appl. No.: 15/782,155

(22) Filed: Oct. 12, 2017

(30) Foreign Application Priority Data
Oct. 13, 2016 (JP) 2016-201979

(51) Int. Cl. C03C 25/10; G02B 6/02; H01S 3/067

(52) U.S. Cl. CPC C03C 25/104; G02B 6/02395; C03C 25/102; H01S 3/06708; G02B 6/02019

(57) ABSTRACT

A manufacturing method of an optical fiber includes forming an optical fiber by forming a plurality of resin-coating layers around a glass fiber including a core part and a cladding part, and forming a marking on an outermost layer, which is a colored layer having pigment, of the plurality of resin-coating layers by melting or scorching a surface of the outermost layer with a laser.

### CROSS-REFERENCE TO RELATED APPLICATION

The present application claims priority from Japanese Patent Application No. 2016-201979 filed on Oct. 13, 2016 the entire content of which is incorporated herein by reference.

### BACKGROUND

### Technical Field

The present invention relates to a manufacturing method of an optical fiber and an optical fiber.

### Related Art

In the related art, for an optical fiber cable of a multi-core, a method of distinguishing each optical fiber by forming marking on a surface of an optical fiber (a line, an optical fiber) through ink application has been adopted (refer to Patent Documents 1 and 2).

In recent years, it is required to expand an effective core area Aeff of an optical fiber so as to efficiently transmit a signal. However, it has been known that a loss is increased due to a lateral pressure in an optical fiber having an effective core area Aeff of 125 μm² or greater. As measures against the loss increase, Patent Document 3 discloses implementing a partial marking on an outermost layer of an optical fiber by controlling an injection amount with a marking device configured to inject ink to the optical fiber.
[Patent Document 1] Japanese Patent Application Publication No. 2005-123041A
[Patent Document 2] Japanese Patent Application Publication No. 2011-191689A
[Patent Document 3] Japanese Patent Application Publication No. Hei11-326714A

However, according to the methods disclosed in Patent Documents 1 and 2, when the ink applied to the optical fiber is cured, a lateral pressure is applied to the optical fiber, which results in the loss increase (this is referred to as ‘micro-bend loss’).

Also, according to the method disclosed in Patent Document 3, further improvements are required with respect to the measure against the loss increase and prevention of detachment of the ink applied to the outermost layer.

### SUMMARY

The exemplary embodiment provides a manufacturing method of an optical fiber for implementing marking on an optical fiber so as to distinguish each of optical fibers in a multi-core cable and to suppress loss increase due to a lateral pressure, and an optical fiber which has the marking.

A manufacturing method of an optical fiber, according to an exemplary embodiment, comprises:

forming a plurality of resin-coating layers around a glass fiber including a core part and a cladding part; and

forming a marking on an outermost layer, which is a colored layer having pigment, of the plurality of resin-coating layers by melting or scorching a surface of the outermost layer with a laser.

Also, an optical fiber according to an exemplary embodiment, comprises;

a glass fiber including a core part and a cladding part: and

a plurality of resin-coating layers formed around the glass fiber,

wherein a resin layer, which is an outermost layer of the plurality of resin-coating layers, is a colored layer having pigment, and

wherein a surface of the colored layer is formed with a marking including a melted portion or a scorched portion.

According to the present invention, it is possible to provide the manufacturing method of an optical fiber for implementing the marking on the optical fiber so as to distinguish each of the optical fibers in the multi-core cable and to suppress the loss increase due to the lateral pressure, and the optical fiber which has the marking.

### BRIEF DESCRIPTION OF THE DRAWINGS

FIG. 1 is a schematic sectional view depicting an example of an optical fiber of the present invention.

FIG. 2 is a pictorial view depicting processing of implementing a marking on the. optical fiber by a laser.

### DETAILED DESCRIPTION

<Outline of Exemplary Embodiment of Present Invention>

First, an outline of an exemplary embodiment of the present invention is described.

(1) A manufacturing method of an optical fiber comprises:

forming a plurality of resin-coating layers around a glass fiber including a core part and a cladding part; and

forming a marking on an outermost layer, which is a colored layer having pigment, of the plurality of resin-coating layers by melting or scorching a surface of the outermost layer with a laser.

According to the above method, the laser is used. Thereby, it is possible to correctly and easily form a desired marking on the colored layer so that each optical fiber can be distinguished, and to suppress loss increase due to a lateral pressure.

(2) A depth of the marking may be equal to or smaller than 3 μm.

The depth of the marking is preferably set to a depth at which the resin-coating layer is not to be badly influenced.

(3) An effective core area of the optical fiber upon transmission of a signal light having a wavelength 1550 nm may be equal to or greater than 125 μm².

The present invention is more preferably applied to an optical fiber having a relatively large effective core area (Aeff) and a condition at which the loss increase is likely to occur.

(4) An optical fiber comprises:

a glass fiber including a core part and a cladding part: and

a plurality of resin-coating layers formed around the glass fiber,

wherein a resin layer, which is an outermost layer of the plurality of resin-coating layers, is a colored layer having pigment, and

wherein a surface of the colored layer is formed with a marking including a melted portion or a scorched portion.

According to the above configuration, it is possible to provide the optical fiber which has the marking so that each of the optical fibers in the multi-core cable can be distinguished and the loss increase due to the lateral pressure can be suppressed.

<Details of Exemplary Embodiment of Present Invention>

Hereinafter, an example of an exemplary embodiment of an optical fiber and a method of manufacturing the same in accordance with the present invention will be described in detail with reference to the drawings.

(Outline of Optical Fiber)

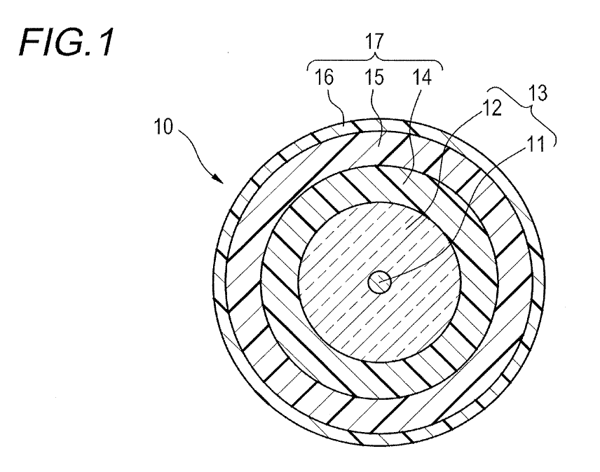

FIG. 1 is a schematic sectional view depicting an example of an optical fiber of the exemplary embodiment.

An optical fiber 10 includes a glass fiber 13 and a resin-coating layer 17 formed on an outer periphery of the glass fiber 13. The glass fiber 13 has a core part 11 and a cladding part 12. For example, for the core part 11, silica having germanium added therein can be used, and for the cladding part 12, pure silica or silica having fluorine added therein can be used. Also, the resin-coating layer 17 has a primary coating layer 14 formed around the cladding part 12, a secondary coating layer 15 formed around the primary coating layer 14 and a colored layer 16. The primary coating layer 14 and the secondary coating layer 15 are formed of an ultraviolet-curable resin composition, for example. For the colored layer 16, for example, an ultraviolet-curable ink having pigment added therein is used.

In FIG. 1, a diameter of the glass fiber 13 is about 125 μm, for example. Also, a diameter of the core part 11 is preferably about 7 to 15 μm. In the resin-coating layer 17, thicknesses of the primary coating layer 14 and the secondary coating layer 15 are substantially the same and are preferably 15 to 40 μm, respectively. Also, a thickness of the colored layer 16 is about 5 μm, for example.

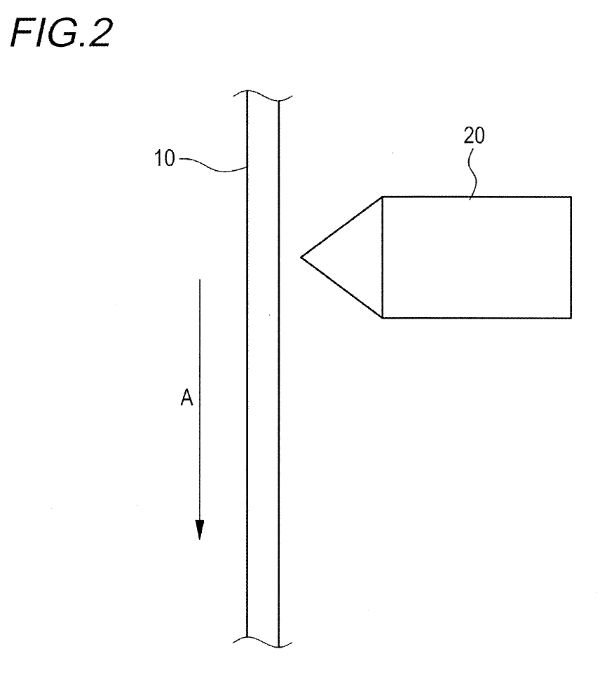

FIG. 2 is a pictorial view depicting processing of implementing a marking on the optical fiber by a laser. First, the primary coating layer 14, the secondary coating layer 15 and the colored layer 16 are formed sequentially around the glass fiber 13 having the core part 11 and the cladding part 12, so that the optical fiber is formed. Then, as shown in FIG. 2, while running the optical fiber 10 in a direction of an arrow A, a surface of the colored layer 16 is melted or scorched at a predetermined position by a laser light emitted from a laser 20. Thereby, it is possible to form a marking on the surface of the colored layer 16. As the laser 20, a CO₂ laser is used, for example. An irradiation intensity and an irradiation time period of the laser light are controlled so that a depth of the marking formed as a laser-melted portion or a scorched portion is to be a depth, for example 3 μm or less at which the secondary coating layer 15 is not to be influenced. A width of the marking is about 1 mm or smaller, for example, and a marking pattern is preferably a pattern in which a shape suitable for distinguishability such as a dot shape and a stripe shape is uniformly formed in a longitudinal direction of the optical fiber 10.

As described above, the method of manufacturing the optical fiber 10 in accordance with the exemplary embodiment includes a process of forming the plurality of resin-coating layers 17 around the glass fiber 13 having the core part 11 and the cladding part 12 to thereby form the optical fiber 10 and a process of melting or scorching the surface of the colored layer 16, which is the outermost layer of the plurality of resin-coating layers 17, with the laser 20 to thereby form the marking on the colored layer 16. According to this method, when forming the marking on the colored layer 16, which is the outermost layer of the optical fiber 10, the irradiation position of the laser light is managed with high precision and in a pinpoint manner, so that the secondary coating layer 15 is not damaged. For this reason, it is possible to suppress the micro-bend loss due to the lateral pressure. Also, it is possible to mark a variety of pattern shapes such as stripe and dot accurately and with high quality by the laser light irradiation, so that it is possible to increase a variation of the marking pattern and to improve the distinguishability of the optical fibers in the multi-core cable.

In the meantime, in the case of a glass fiber for which the lateral pressure resistance is not strictly required, the colored layer 16 may not be provided and a surface of the secondary coating layer may be melted or scorched by the laser 20. In this case, the secondary coating layer may be configured as a colored layer (outermost layer) by adding pigment to the ultraviolet-curable resin composition constituting the secondary coating layer. Also in this configuration, it is possible to provide the optical fiber which has the marking so that each of the optical fibers in the multi-core cable can be distinguished and the loss increase due to the lateral pressure can be suppressed.

### EXAMPLES

A mesh lateral pressure test was performed for Example 1 to Example 3 so as to evaluate whether the micro-bend loss was good or bad. In the Examples, the favorable micro-bend loss indicates that a difference between a transmission loss (micro-bend loss) upon winding on a bobbin and a transmission loss at a coil state in the mesh lateral pressure test is 0.6 dB/km or less. In the mesh lateral pressure test, the optical fiber was wound on a bobbin, on which the metal mesh material was wound on a body (a diameter 250 mm) without a gap, with tensile force 80 g and a transmission loss value a of a signal light having a wavelength 1550 nm was measured for the optical fiber wound on the bobbin. The metal mesh material used in the mesh lateral pressure test had a mesh shape in which a plurality of metal lines is networked in vertical and horizontal directions. A vertical wire diameter ϕ1 and a horizontal wire diameter ϕ2 of the metal mesh material were 50 μm, for example. A pitch P between center-lines of the vertical wires and between center-lines of the horizontal wire was 150 μm, for example. Subsequently, a transmission loss value β of a signal light having a wavelength 1550 nm was measured for the optical fiber at a coil state (a state where the optical fiber is separated from the bobbin) where the optical fiber was not wound on the bobbin and was wound with the substantially same diameter (280 mm) as the body of the bobbin. Finally, a difference between the transmission loss value α and the transmission loss value β was obtained. When the difference was 0.6 dB/km or less, the micro-bend loss was determined as “favorable” and when the difference was greater than 0.6 dB/km, the micro-bend loss was determined as “bad”.

### Example 1

The optical fiber where the resin-coating layer has the primary coating layer, the secondary coating layer and the colored layer (ink layer) was used, and the colored layer was illuminated with the CO₂ laser and formed with a marking having a depth 3 μm and a diameter 0.26 mm. Meanwhile, in all of Example 1 to Example 3, an optical fiber of which the effective core area Aeff upon transmission of the signal light having the wavelength 1550 nm is 125 μm² and an optical fiber the Aeff of which is 150 μm² were used. For the optical fiber having the marking formed thereon, the mesh lateral pressure test was performed to measure the micro-bend loss. As a result, the micro-bend loss was 0.4 dB/km or less and was determined as “favorable”. Also, the marking was formed with a blackish color and the distinguishability thereof was favorable.

### Example 2

The optical fiber where the resin-coating layer has the primary coating layer and the secondary colored coating layer having pigment added therein was used, and the secondary coating layer was illuminated with the CO₂ laser and formed with a marking having a depth 3 μm and a diameter 0.26 mm. For the optical fiber having the marking formed thereon, the mesh lateral pressure test was performed to measure the micro-bend loss. As a result, the micro-bend loss was 0.4 dB/km or less and was determined as “favorable”. Also, the marking was formed with a blackish color and the distinguishability thereof was favorable.

### Example 3

Like Patent Document 1, for the optical fiber where the outermost layer of the resin-coating layer was formed with a dot marking (a diameter of the marking: 0.26 mm), the mesh lateral pressure test was performed to measure the micro-bend loss. As a result, the distinguishability of the marking layer was favorable but the micro-bend loss was greater 0.6 dB/km and determined as “bad”.

According to the method of the exemplary embodiment, it is possible to confirm that the loss increase can be suppressed by implementing the marking on the colored layer, which is the outermost layer of the optical fiber. In particular, it is possible to confirm that it is preferable to apply the method of the exemplary embodiment to the optical fiber of which the effective core area Aeff upon transmission of the signal light having the wavelength 1550 nm is 125 μm² or greater, i.e., the optical fiber having the relatively large effective core area Aeff and a condition at which the loss increase is likely to occur.

Although the present invention has been described in detail with reference to the specific exemplary embodiment, it is obvious to one skilled in the art that a variety of changes and modifications can be made without departing from the spirit and scope of the present invention. Also, the number, positions, shapes and the like of the constitutional elements are not limited to the exemplary embodiment and can be changed to the number, positions, shapes and the like suitable for implementation of the present invention.

What is claimed is:

1. A manufacturing method of an optical fiber, comprising:
forming a plurality of resin-coating layers around a glass fiber including a core part and a cladding part; and
forming a marking on an outermost layer, which is a colored layer having pigment, of the plurality of resin-coating layers by melting or scorching a surface of the outermost layer with a laser.

2. The manufacturing method of the optical fiber according to claim 1, wherein a depth of the marking is equal to or smaller than 3 μm.

3. The manufacturing method of the optical fiber according to claim 1, wherein an effective core area of the optical fiber upon transmission of a signal light having a wavelength 1550 nm is equal to or greater than 125 μm².

4. The manufacturing method of the optical fiber according to claim 2, wherein an effective core area of the optical fiber upon transmission of a signal light having a wavelength 1550 nm is equal to or greater than 125 μm².

5. An optical fiber comprising:
a glass fiber including a core part and a cladding part: and
a plurality of resin-coating layers formed around the glass fiber,
wherein a resin layer, which is an outermost layer of the plurality of resin-coating layers, is a colored layer having pigment, and
wherein a surface of the colored layer is formed with a marking including a melted portion or a scorched portion.

6. The optical fiber according to claim 5, wherein a depth of the marking is equal to or smaller than 3 μm.

7. The optical fiber according to claim 5, wherein an effective core area of the optical fiber upon transmission of a signal light having a wavelength 1550 nm is equal to or greater than 125 μm².

8. The optical fiber according to claim 6, wherein an effective core area of the optical fiber upon transmission of a signal light having a wavelength 1550 nm is equal to or greater than 125 μm².
